(19) United States
(12) Patent Application Publication
(10) Pub. No.: US 2008/0203225 A1
(43) Pub. Date: Aug. 28, 2008

(54) Multiple support disc loader

(75) Inventor: Ralph Franklin Brandt, Gloucester, VA (US)

Correspondence Address: RALPH F. BRANDT, JR., 9503 LAURELWOOD LN., GLOUCESTER, VA, 23061-3036, US

(73) Assignee: Ralph Franklin Brandt, Gloucester, VA (US)

(21) Appl. No.: 11/680,025

(22) Filed: Feb. 28, 2007

(51) Int. Cl. B64F 1/02

(52) U.S. Cl. 244/110 C

(57) ABSTRACT

The present invention is a portable engine powered horizontal action aircraft landing barrier arresting cable disc loading apparatus which includes an engine powered hydraulic pump; manual hydraulic pump; an elongated frame; a transverse axle having a reservoir for hydraulic fluid; a hydraulic cylinder and ram/piston secured to one end of the frame and a system of staves comprised partially of the elongated frame and slotted plates affixed at regular intervals along the longitudinal length opposite the hydraulic cylinder. The ram/piston is configured with a chain attachment hook which is movable toward and away from the staves and provides a longitudinal pulling force with respect to the staves. Multiple staves are provided to divide the pulling force between groups of the total number of discs to be loaded. The present invention has internal power redundancy and has a means of accessing external power for secondary redundancy.

### FIELD OF THE INVENTION

The present invention relates to the maintenance of mobile aircraft arresting energy absorbing systems used on airport runways to safely break the progress of a landing aircraft. Specifically, the present invention relates to steel wire rope arresting barrier cable type aircraft systems which employ round rubber support discs to elevate the cable a few inches above the runway surface as to allow a landing aircraft's tail hook to capture the cable.

### BACKGROUND OF THE INVENTION

Mobile Aircraft Arresting Systems (M.A.A.S) energy absorbing apparatus are used on aircraft runways (including military) to provide a means of breaking the progress of landing aircraft. M.A.A.S. units are deployed on permanent and temporary runways. M.A.A.S. units generally consist of a friction brake, reel and nylon strap on either side of the runway with a steel wire rope arresting cable in between. The arresting cable is supported three inches above the runway by rubber support discs spaced every six feet. The rubber support discs have a hole in the center for the arresting cable to pass through. The hole in the center of the rubber support disc is slightly larger than the steel wire rope arresting cable but, smaller than the crimped end of the cable thus making necessary an apparatus to load the discs. The rubber support discs are stretched when being loaded past the crimped end of the steel wire rope arresting cable. During aircraft landings, the rubber support discs are damaged and require replacement. Present disc loading of aircraft barrier arresting cable is accomplished manually with a modified mechanical ratchet jack that takes two barrier maintenance technicians to operate and expends thirty minutes time to load twenty-five support discs onto a one-hundred and fifty foot arresting cable.

### SUMMARY OF THE INVENTION

The present invention is directed to the quick and safe replacement of rubber support discs onto arresting barrier steel wire rope cables. The present invention is intended for use by airfield technicians (including military) who maintain steel wire rope arresting barrier cable type aircraft systems deployed on temporary and permanent runways.

### BRIEF DESCRIPTION OF DRAWINGS

FIG. 1 is a three dimensional view showing the assembled arraingement of the component parts of the invention.

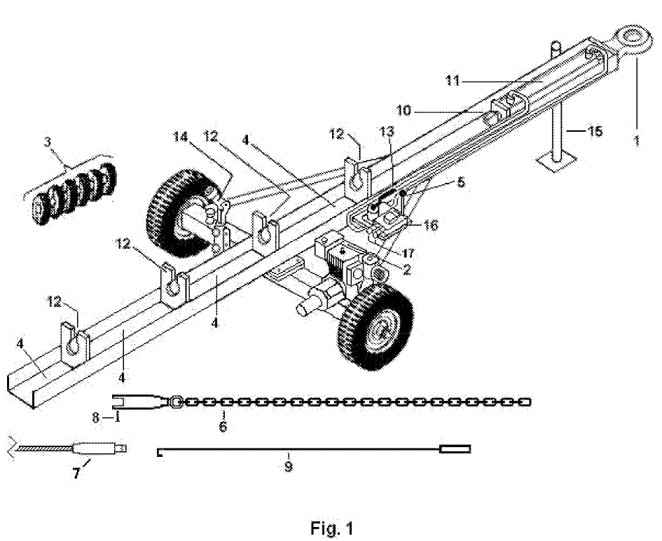

FIG. 2 is a schematic representation showing the hydraulic circuit diagram of the invention.

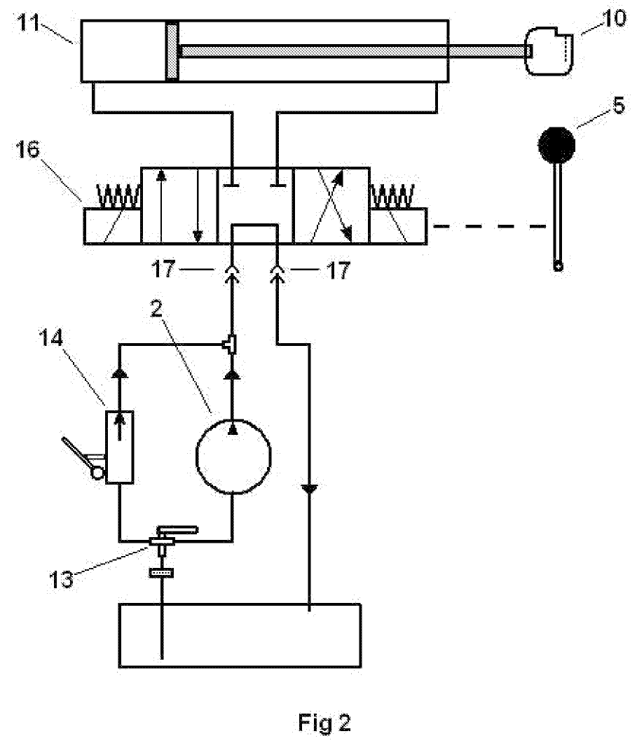

### DETAILED DESCRIPTION OF THE PREFERRED EMBODIMENT

The nature and mode of operation of the present invention will now be described in the following detailed description taken with the accompanying drawings.

The Multiple Support Disc Loader is a portable apparatus used to install rubber support discs onto an aircraft barrier arresting cable of a Mobile Aircraft Arresting System (M.A.A.S.). The Apparatus can be towed by ring hitch (1). Apparatus is operated as follows: Engine/pump (2) is started to provide hydraulic pressure that is converted to linear mechanical force by cylinder (11). The direction of motion of the chain hook (10) is controlled by extend/retract lever (5) and extend/retract valve (16). Twenty five rubber support discs (3) (for 150 ft arresting cable) are loaded into staves (4). Extend/retract lever (5) is moved to the extend position. Mandrel end of loader chain assembly (6) is fastened to the crimped end of aircraft arresting cable (7) with pin (8). Chain fish tool (9) is fed through hole in center of rubber support discs (3). Chain fish tool (9) is hooked to free end of loader chain assembly (6). Chain is pulled through hole in center of rubber support discs (3). Chain is attached to chain hook (10) as to eliminate slack. Extend/retract lever (5) is moved to the retract position providing force to pull the crimped end of arresting (7) through support discs until cylinder (11) is fully retracted. Extend/retract lever (5) is moved to the extend position until cylinder (11) is fully extended. Chain is detached from the chain hook (10). Previous four steps are repeated. Mandrel end of loader chain assembly (6) is detached from aircraft barrier arresting cable by removing pin (8). Aircraft arresting cable with loaded rubber support discs is lifted out of apparatus through slots (12). Hydraulic quick disconnects (17) on extend/retract valve (16) are provided for redundant power input from M.A.A.S. hydraulic power unit. Reconfiguration valve (13) and hand pump (14) are provided for secondary redundancy. Folding jack (15) is provided for support when apparatus is not towed.

1. The present invention, Multiple Support Disc Loader (MSDL), is a lightweight, portable, and engine powered ‘aircraft landing barrier arresting cable’ multiple disc loading apparatus which can be towed to it's required work location. The MSDL has a unique system of staves with slotted ends to divide the pulling force between four groups of rubber discs to be loaded thus minimizing disc distortion during the loading process which could cause an unsafe condition for the barrier maintenance technician or damage the discs resulting in loss of disc reliability and longevity thus impacting landing safety. The MSDL is capable of loading twenty-five support discs in one operation, by one technician in less than one minute, thus providing quick recovery of aircraft barrier arresting system and allowing higher aircraft landing rates. The MSDL is compatible with many Mobile Aircraft Arresting Systems (M.A.A.S) including the U.S. Navy and Marines E-5, and E-28 models and U.S. Air Force BAK-9 and BAK-12 models. The MSDL has a double detent control valve that returns to the “OFF” position automatically when a preset pressure is reached, usually at the end of cylinder travel. The MSDL has multiple power redundancy by either connecting it to the M.A.A.S. Hydraulic Power Unit via quick disconnect hydraulic couplings or by selecting the built-in hand pump with a reconfiguration valve. The apparatus is designed to be partially disassembled with four easily removable bolts and two quick disconnect couplings to minimize required shipping space during deployment.
